(19) United States
(12) Patent Application Publication
(10) Pub. No.: US 2026/0177485 A1
(43) Pub. Date: Jun. 25, 2026

(54) MEASUREMENT DEVICE

(71) Applicant: FUJIFILM CORPORATION, Tokyo (JP)

(72) Inventor: Yoshinori TANAKA, Kanagawa (JP)

(21) Appl. No.: 19/542,673

(22) Filed: Feb. 18, 2026

Related U.S. Application Data
(63) Continuation of application No. PCT/JP2024/029359, filed on Aug. 19, 2024.

(30) Foreign Application Priority Data
Aug. 30, 2023 (JP) 2023-140446

(51) Int. Cl. G01N 21/64

(52) U.S. Cl. CPC G01N 21/6428; G01N 2021/6439; G01N 2201/0231

(57) ABSTRACT

A measurement device that uses a measurement chip having a reaction region for detecting a test substance and measures a reaction of the test substance in the reaction region by using fluorescence, the measurement device including a measurement unit that irradiates the reaction region with excitation light and detects the fluorescence emitted from the reaction region, a mounting part to which the measurement chip is attachably and detachably mounted, a check chip for checking the measurement unit, the check chip being attachably and detachably mounted to the mounting part, and a storage part that stores the check chip and is provided at a location different from the mounting part.

### CROSS-REFERENCE TO RELATED APPLICATIONS

This application is a continuation application of International Application No. PCT/JP2024/029359, filed Aug. 19, 2024, the disclosure of which is incorporated herein by reference in its entirety. Further, this application claims priority from Japanese Patent Application No. 2023-140446, filed on Aug. 30, 2023, the disclosure of which is incorporated herein by reference in its entirety.

### BACKGROUND

### 1. Technical Field

The present disclosed technology relates to a measurement device.

### 2. Description of the Related Art

As in the measurement device described in JP2014-071056A, a measurement device that uses a measurement chip having a reaction region for detecting a test substance to measure a reaction of the test substance in the reaction region is known. In the measurement device described in JP2014-071056A, the reaction is measured by irradiating the reaction region with excitation light and detecting fluorescence excited by the excitation light.

In the measurement device described in JP2014-071056A, a calibration region for performing optical calibration of a measurement unit including a light source that irradiates the excitation light and a detection unit that detects the fluorescence is provided. In a case where the calibration region is provided outside the measurement chip, the calibration region is provided on a side of a mounting part to which the measurement chip is mounted. In addition, in a case where the calibration region is provided inside the measurement chip, the calibration region is provided on a side of the reaction region of the measurement chip.

### SUMMARY

As a method of performing a check of the measurement unit, such as calibrating the measurement unit described in JP2014-071056A, it has been studied to prepare a check chip used exclusively for checking, which is separate from a measurement chip and is attachable to and detachable from the mounting part. By using such a check chip, the following advantages are provided as compared with the method described in JP2014-071056A.

One is that there is less concern that the device configuration will be complicated as compared with a method of providing a check region such as the calibration region described in JP2014-071056A in the measurement device outside the measurement chip. That is, since the check region can be provided in the check chip instead of the measurement device, it is not necessary to greatly change the irradiation position of the excitation light from the time of measurement in a case of checking the measurement unit, and there is less concern that the device configuration will be complicated.

Another is that the cost of the measurement chip can be suppressed as compared with a method of providing the check region inside the measurement chip. This is because, in a case where the check region is provided in every measurement chip, the cost of the measurement chip is increased; however, by preparing a check chip, it is unnecessary to provide a check region in the measurement chip.

However, in a case where the check chip used exclusively for checking is prepared separately from the measurement chip in this way, there is a concern that another problem of losing the check chip during a period in which the check chip is not used will occur.

One embodiment according to the present disclosed technology provides a measurement device in which there is less concern that the check chip will be lost even in a case where the check chip for checking the measurement unit is used.

In order to achieve the above object, a measurement device according to an aspect of the present disclosed technology is a measurement device that uses a measurement chip having a reaction region for detecting a test substance and measures a reaction of the test substance in the reaction region by using fluorescence, the measurement device comprising a measurement unit that irradiates the reaction region with excitation light and detects the fluorescence emitted from the reaction region, a mounting part to which the measurement chip is attachably and detachably mounted, a check chip for performing a check of the measurement unit, the check chip being attachably and detachably mounted to the mounting part and a storage part that stores the check chip and is provided at a location different from the mounting part.

It is preferable that the check chip has a check region for performing an optical check of the measurement unit, and a position of the check region in a case where the check chip is mounted to the mounting part is the same as a position of the reaction region in a case where the measurement chip is mounted to the mounting part.

It is preferable that the check chip has a check region that emits fluorescence by being irradiated with the excitation light.

It is preferable that a housing that accommodates the measurement unit and the mounting part is provided with an opening and closing mechanism configured to open and close an opening formed in the housing, and the storage part is provided inside the housing at a position where the check chip stored in the storage part is extractable in a case where the opening and closing mechanism is opened.

It is preferable that the opening is a maintenance opening provided for maintenance.

It is preferable that the maintenance opening is a maintenance opening for the measurement unit.

It is preferable that a maintenance door that opens and closes the maintenance opening is provided as the opening and closing mechanism, and the storage part is provided on an inner side of the maintenance door.

It is preferable that the storage part is provided inside the housing at a location where a temperature difference from an environment in which the measurement unit is disposed is within 10° C.

It is preferable that the temperature difference is within 5° C.

It is preferable that the reaction is measured by using surface plasmon resonance.

According to the present disclosed technology, there is less concern that the check chip will be lost even in a case where the check chip for performing a check of the measurement unit is used.

### BRIEF DESCRIPTION OF THE DRAWINGS

FIG. 1 is an external view of a measurement device according to the present disclosure.

FIG. 2 is a block diagram showing an outline of an internal configuration of the measurement device.

FIG. 3 is a schematic diagram showing an example of an analysis chip used in the measurement device.

FIG. 4 is a schematic diagram showing a state in which a specimen is extracted from a specimen container by using a nozzle tip by a specimen processing unit.

FIG. 5 is a schematic diagram showing a state in which the specimen in the nozzle tip is injected and stirred into a reagent cell by the specimen processing unit.

FIG. 6 is a diagram showing a positional relationship between a flow channel and the measurement unit and a moving method of the measurement unit.

FIG. 7 is a diagram illustrating an outline of fluorescence detection using the measurement unit.

FIG. 8 is a diagram showing an incidence angle of excitation light and a plasmon enhancement degree.

FIG. 9 is a diagram showing a configuration of a check chip.

FIG. 10 is a diagram showing a positional relationship between a check region of the check chip and a measurement target.

FIG. 11 is a diagram illustrating an outline of a checking process using the check chip.

FIG. 12 is a diagram showing a storage part of the check chip.

FIG. 13 is a diagram showing a positional relationship between the storage part and the measurement unit.

FIG. 14 is a graph showing a relationship between a viscosity of a specimen solution and a flow velocity.

FIG. 15 is a diagram showing a modification example of the storage part.

### DETAILED DESCRIPTION

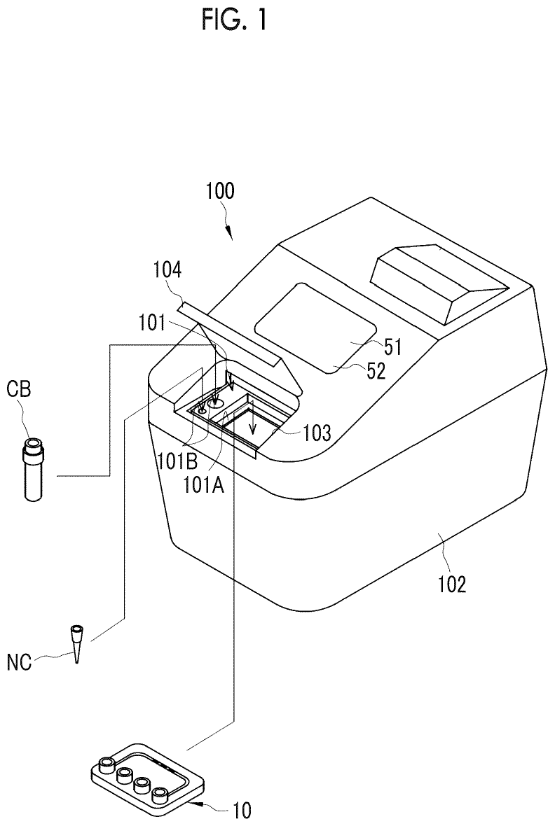

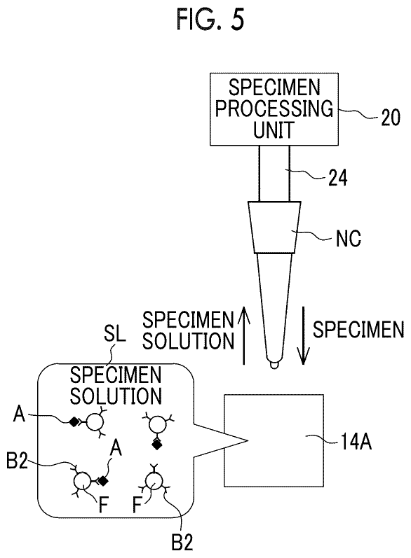

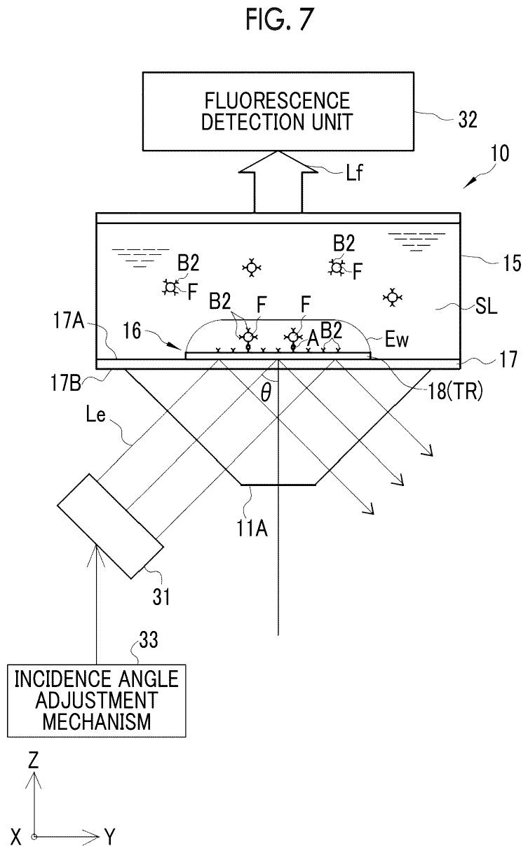

A measurement device 100 shown in FIG. 1 is, for example, a measurement device that measures an antigen-antibody reaction of a test substance A (see FIGS. 4 and 5) contained in a specimen collected from a living body in order to perform immunodiagnosis. The measurement device 100 is, for example, a measurement device using a fluorescence method. The fluorescence method is a measurement method of measuring the antigen-antibody reaction of the test substance A by irradiating a fluorescence label F (see FIGS. 5 and 7) bound to the test substance A with excitation light and detecting the fluorescence generated from the fluorescence label F. More specifically, the measurement device 100 measures the antigen-antibody reaction of the test substance A by enhancing the fluorescence emitted from the fluorescence label F by using a surface plasmon resonance phenomenon. Such a measurement method is called surface plasmon field-enhanced fluorescence spectroscopy (SPFS) or the like.

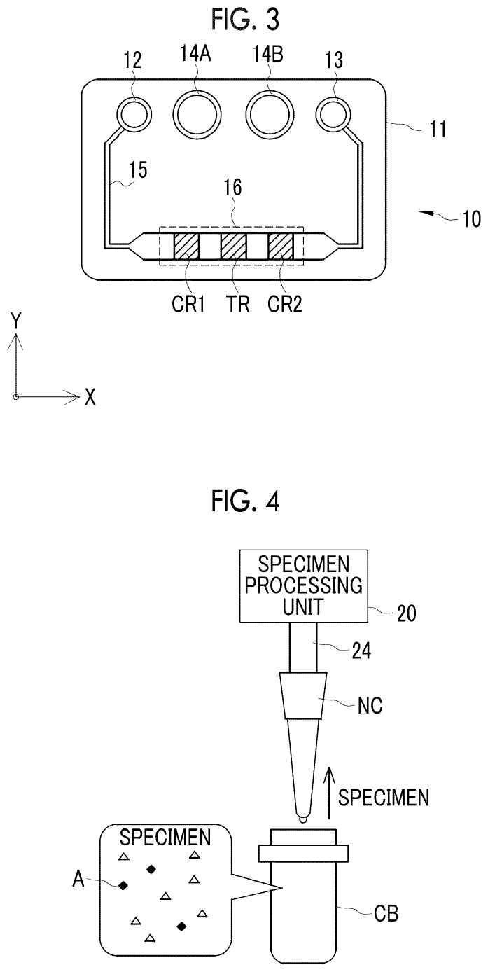

As shown in FIG. 1, in a case of performing the measurement using the measurement device 100, a specimen container CB accommodating the specimen, a nozzle tip NC used in a case of extracting the specimen and a reagent, and an analysis chip 10 on which a reagent cell and a microchannel are formed are set in the measurement device 100. It should be noted that the specimen container CB, the nozzle tip NC, and the analysis chip 10 are all disposable items that are discarded after being used once. In addition, the measurement device 100 injects the specimen into the flow channel 15 (see FIG. 3) of the analysis chip 10 to perform quantitative measurement of the test substance A in the specimen as an example. The analysis chip 10 is an example of a “measurement chip” according to the present disclosed technology. In addition, the analysis chip 10 is also called an analysis cartridge, a measurement cartridge, or the like.

The specimen is, for example, blood, and more specifically, serum, blood plasma, or whole blood. It should be noted that the specimen may be other than blood, and may be urine, nasal fluid, saliva, feces, body cavity fluid, or the like. The test substance A contained in the specimen is, for example, a nucleic acid, a protein, an amino acid, a sugar, a lipid, a modified molecule thereof, a complex, or the like. The complex may be, for example, a tumor marker, a signal transduction substance, a hormone, or the like.

An opening portion 103 that is opened in a case of mounting the analysis chip 10 and the like and an operation panel including an operation part 51 and a display part 52 are provided on an upper surface of a housing 102 of the measurement device 100. A mounting part 101 that mounts the analysis chip 10 is provided behind the opening portion 103. The mounting part 101 is provided with a main mounting part 101A to which the analysis chip 10 is mounted and a sub-mounting part 101B to which each of the specimen container CB and the nozzle tip NC is mounted. The analysis chip 10 is attachably and detachably mounted to the main mounting part 101A. The specimen container CB and the nozzle tip NC are also attachable to and detachable from the sub-mounting part 101B.

A cover 104 is a cover that opens and closes the opening portion 103. As shown in FIG. 1, in a case where the cover 104 is opened, the mounting part 101 is exposed from the opening portion 103, and the analysis chip 10 and the like can be mounted. In a case of performing the measurement, the cover 104 is closed.

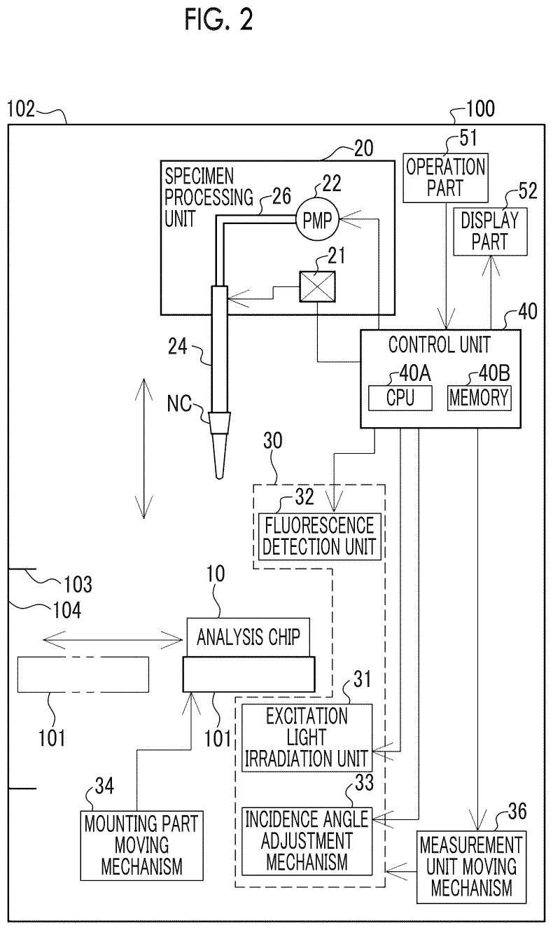

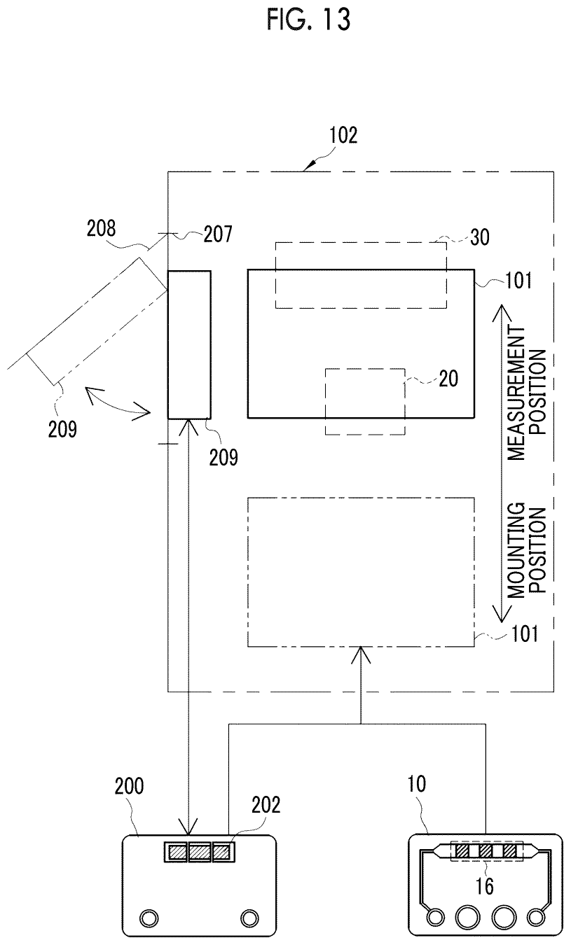

In FIG. 2 schematically showing the internal configuration of the measurement device 100, the measurement device 100 comprises a specimen processing unit 20, a measurement unit 30, a control unit 40, and the like, in addition to the mounting part 101. The mounting part 101 moves between a mounting position and a measurement position in the measurement device 100 (see also FIG. 13). The mounting position is a position corresponding to the opening portion 103 and is a position at which the analysis chip 10 and the like are mounted. The measurement position is a position at which the measurement unit 30 is disposed and is a position at which the measurement is performed on the analysis chip 10. For example, the mounting position is disposed in front of the housing 102 in a depth direction, and the measurement position is disposed behind the mounting position. A mounting part moving mechanism 34 moves the mounting part 101 between the mounting position and the measurement position.

As shown in FIG. 1, since the nozzle tip NC and the specimen container CB are mounted to the mounting part 101 in addition to the analysis chip 10, the nozzle tip NC and the specimen container CB are also transported to the measurement position by moving the mounting part 101 to the measurement position.

The specimen processing unit 20 extracts the specimen from the specimen container CB (see FIG. 4) by using the nozzle tip NC and generates a specimen solution SL (see FIG. 5) obtained by mixing and stirring the extracted specimen with a reagent. In addition, the specimen processing unit 20 injects the generated specimen solution SL into the analysis chip 10.

Specifically, the specimen processing unit 20 comprises a nozzle moving mechanism 21, a pump 22, and the like. The nozzle moving mechanism 21 is a mechanism for moving a nozzle 24 in an up-down direction and a left-right direction. The pump 22 is connected to the nozzle 24 via a pipe 26 and performs discharge and suction of a liquid such as the specimen through a gas. A single-use nozzle tip NC is attached to a distal end of the nozzle 24. The nozzle tip NC is replaced for each specimen, and the used nozzle tip NC is discarded. As a result, contamination between different specimens is prevented. The specimen processing unit 20 acquires the nozzle tip NC from the mounting part 101 at the measurement position. In addition, the specimen processing unit 20 accesses the specimen container CB and the analysis chip 10 mounted to the mounting part 101 through the nozzle moving mechanism 21.

The measurement unit 30 measures the reaction of the test substance A contained in the specimen solution SL injected into the analysis chip 10 by using the fluorescence method that uses the surface plasmon resonance. The measurement unit 30 comprises an excitation light irradiation unit 31, an incidence angle adjustment mechanism 33, a fluorescence detection unit 32, and the like.

The excitation light irradiation unit 31 irradiates the analysis chip 10 with excitation light Le (see FIG. 7). The excitation light irradiation unit 31 is configured, for example, with a laser diode (LD) that serves as a light-emitting unit which emits the excitation light Le and a reflection mirror that reflects the excitation light Le. The incidence angle adjustment mechanism 33 adjusts an incidence angle of the excitation light Le to be emitted to the analysis chip 10. The fluorescence detection unit 32 detects the fluorescence Lf (see FIG. 7) emitted from the fluorescence label F excited by the excitation light Le in the analysis chip 10 and outputs a fluorescence detection signal to the control unit 40. The fluorescence detection unit 32 is configured with a photodiode, a photomultiplier, a charge coupled device (CCD) image sensor, a complementary metal oxide semiconductor (CMOS) image sensor, or the like.

A measurement unit moving mechanism 36 is a moving mechanism that moves the measurement unit 30. As will be described below, a plurality of regions to be measured are provided in the analysis chip 10, and the measurement unit moving mechanism 36 moves the measurement unit 30 with respect to the analysis chip 10 such that the measurement can be performed on a plurality of regions of the analysis chip 10.

The control unit 40 comprehensively controls each unit of the measurement device 100. The operation part 51 and the display part 52 are connected to the control unit 40. In addition, the control unit 40 is provided with a timer (not shown) that performs various types of timing. The operation part 51 is configured with a button, a cross key, and the like, and inputs an operation instruction such as a measurement start instruction to the control unit 40. In addition, input of patient information related to the specimen and the like is also performed through the operation part 51. The display part 52 is configured with, for example, a liquid crystal panel, and displays a measurement result, a status indicating an operation state, a message such as a warning, and the like.

In response to the measurement start instruction from the operation part 51, the control unit 40 controls the specimen processing unit 20 to inject the specimen solution SL into the analysis chip 10. Then, the measurement is performed by operating the measurement unit moving mechanism 36 and the measurement unit 30. During the measurement, the control unit 40 outputs, as an example, a concentration of the test substance A as the measurement result based on the fluorescence detection signal acquired from the fluorescence detection unit 32. It should be noted that data analysis may be performed based on the concentration, and the analysis result may be included in the measurement result and output, in addition to the concentration of the test substance A. The control unit 40 outputs the measurement result to the display part 52.

The control unit 40 comprises, for example, a central processing unit (CPU) 40A and a memory 40B. In addition, the control unit 40 is communicably connected to a data storage (not shown) (not shown). As is well known, the CPU 40A executes processing defined in a program by executing the program loaded in the memory 40B. The memory 40B includes a random access memory (RAM) and a read only memory (ROM). The data storage is a hard disk drive (HDD), a solid state drive (SSD), or the like.

FIG. 3 is a schematic diagram showing an example of the analysis chip 10. The analysis chip 10 has a structure in which an inlet port 12, an outlet port 13, reagent cells 14A and 14B, and a flow channel 15 are formed in a body 11 formed of a dielectric such as a light-transmissive resin. The inlet port 12 communicates with the outlet port 13 via the flow channel 15. The specimen solution SL is injected from the inlet port 12 and is supplied to the flow channel 15. The reagent cells 14A and 14B are containers that accommodate a fluorescence reagent to be mixed with the specimen in the specimen container CB. The fluorescence reagent is subjected to pretreatment such as adsorbing to a protein in the specimen for pH adjustment to dissociate the target. It should be noted that opening portions of the reagent cells 14A and 14B are sealed with a sealing member, and the sealing member is perforated in a case of mixing the specimen and the fluorescence reagent.

In addition, a reaction region 16 for detecting the test substance A in the specimen is provided in the flow channel 15. A test region TR, a first control region CR1, and a second control region CR2 are formed in the reaction region 16. In the flow channel 15, in a case where a side on which the inlet port 12 is provided is defined as an upstream side of the reaction region 16, the first control region CR1, the test region TR, and the second control region CR2 are provided in this order from the upstream side to a downstream side.

A first antibody B1 (see FIG. 7) is immobilized on the test region TR to capture the test substance A. The first antibody B1 is an example of an antibody that specifically reacts with the test substance A. In addition, the first control region CR1 is a region that does not capture anything under normal circumstances, and is a so-called negative type control region in which a signal value serving as a base of the fluorescence detection signal is 0. The second control region CR2 is a region in which a substance that captures the fluorescence label F in the specimen solution SL is immobilized. The second control region CR2 captures the fluorescence label F regardless of whether or not the fluorescence label F is bound to the test substance A. Therefore, the second control region CR2 is a region in which the signal value serving as a base of the fluorescence detection signal is a value corresponding to the concentration of the fluorescence label F contained in the specimen solution SL, and is a so-called positive type control region. For example, a specimen abnormality, a measurement abnormality, and the like are detected based on the fluorescence detection signals of the first control region CR1 and the second control region CR2.

Then, in a case where the measurement start is instructed, the specimen processing unit 20 attaches the nozzle tip NC to the nozzle 24 and suctions the specimen from the specimen container CB by using the nozzle tip NC as shown in FIG. 4. Thereafter, as shown in FIG. 5, the specimen processing unit 20 perforates the sealing member of the reagent cell 14A, mixes and stirs the specimen with the reagent in the reagent cell 14A, and then suctions the specimen solution SL again by using the nozzle tip NC. The same operation is performed on the reagent cell 14B. The reagent is a reagent in which a second antibody B2 is labeled with the fluorescence label F. The second antibody B2 specifically binds to the test substance A present in the specimen. Therefore, by mixing and stirring the specimen and the reagent, the specimen solution SL in which the second antibody B2 and the fluorescence label F are modified on a surface of the test substance A by the binding of the second antibody B2 and the test substance A is generated.

Then, the specimen processing unit 20 moves the nozzle tip NC accommodating the specimen solution SL to above the inlet port 12. The specimen processing unit 20 injects the specimen solution SL into the inlet port 12 by a discharge operation of the nozzle 24 from above the inlet port 12. As a result, a liquid pool of the specimen solution SL is formed inside the inlet port 12. Thereafter, the specimen processing unit 20 removes the nozzle tip NC from the nozzle 24, inserts a distal end of the nozzle 24 into the outlet port 13, and performs the suction operation in this state. As a result, the specimen solution SL in a liquid pool state inside the inlet port 12 is supplied to the flow channel 15. The specimen solution SL supplied to the flow channel 15 flows in the flow channel 15 to the downstream side and comes into contact with the reaction region 16.

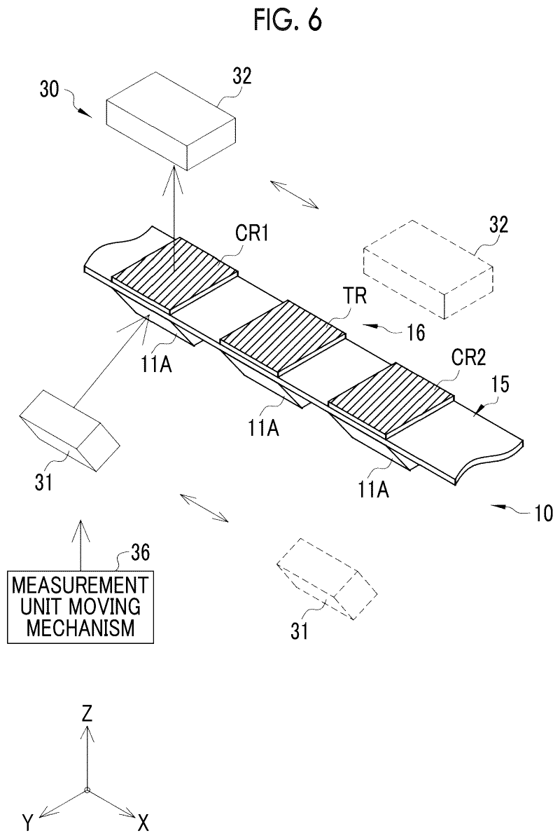

FIG. 6 is an explanatory diagram showing a state in which the measurement unit 30 moves with respect to the analysis chip 10, the first control region CR1, the test region TR, and the second control region CR2 of the analysis chip 10. The first control region CR1, the test region TR, and the second control region CR2 are disposed along a flow direction (X direction) of the specimen solution SL in the flow channel 15. In the body 11, a prism 11A having an incident surface on which the excitation light Le is incident is provided corresponding to each of the first control region CR1, the test region TR, and the second control region CR2.

In the measurement unit 30, the excitation light irradiation unit 31 is disposed at a position facing the incident surface of the prism 11A of the analysis chip 10 mounted to the mounting part 101 at the measurement position. On the other hand, the fluorescence detection unit 32 is disposed at a position facing the first control region CR1, the test region TR, and the second control region CR2 above the flow channel 15 of the analysis chip 10, and is disposed at a position where fluorescence from each region can be detected.

The measurement unit moving mechanism 36 (see FIG. 2) linearly moves the excitation light irradiation unit 31 and the fluorescence detection unit 32 along the flow direction (X direction) of the flow channel 15, that is, the arrangement direction of the first control region CR1, the test region TR, and the second control region CR2. As a result, the measurement unit 30 can selectively move to a position facing each of the first control region CR1, the test region TR, and the second control region CR2 to measure the reaction of each region.

FIG. 7 is an explanatory diagram showing a relationship between the reaction region 16 of the analysis chip 10 and the excitation light irradiation unit 31 and the fluorescence detection unit 32 as viewed from the X direction. It should be noted that, in FIG. 7, the test region TR will be described, but the same applies to the first control region CR1 and the second control region CR2.

The body 11 of the analysis chip 10 includes a dielectric plate 17. A front surface 17A of the dielectric plate 17 constitutes a bottom surface of the flow channel 15, and the prism 11A is provided on a back surface 17B. A metal film 18 constituting the test region TR, the first control region CR1, and the second control region CR2 is formed on the dielectric plate 17. A material of the metal film 18 is gold in the present example. The dielectric plate 17 and the prism 11A are integrally molded, and the prism 11A is also a dielectric.

In the dielectric plate 17, the front surface 17A corresponds to a main surface that is in contact with a back surface of the metal film 18 opposite to a surface on which the test region TR is provided.

As described above, the first antibody B1 is immobilized on the metal film 18 of the test region TR, and the first antibody B1 captures the test substance A modified with the fluorescence label F and the second antibody B2 by a so-called sandwich method. As described above, the first control region CR1 is a negative type control region, and no antibody is immobilized on the metal film 18 of the first control region CR1 as an example. That is, the first control region CR1 is merely the metal film 18. In addition, as described above, the second control region CR2 is a positive type control region, and a substance that captures the fluorescence label F regardless of the presence or absence of the test substance A is immobilized on the metal film 18 of the second control region CR2.

The excitation light irradiation unit 31 causes the excitation light Le to be incident, from a back side of the front surface 17A of the dielectric plate 17 in contact with the back surface of the metal film 18, on the surface 17A via the prism 11A. An incidence angle θ of the optical axis with respect to the surface 17A is an angle equal to or larger than a critical angle satisfying a total reflection condition. As a result, the excitation light Le is emitted to the back surface of the metal film 18 of the test region TR, the first control region CR1, and the second control region CR2. As described above, the excitation light irradiation unit 31 is provided with a reflection mirror. The reflection mirror can be rotationally moved, and the excitation light irradiation unit 31 can change the incidence angle θ of the excitation light Le by rotationally moving the reflection mirror. The incidence angle adjustment mechanism 33 adjusts the incidence angle of the excitation light Le by rotationally moving the reflection mirror by using a lens or the like without changing the irradiation position of the excitation light Le on the back surface of the metal film 18.

The excitation light Le is incident on the back surface of the metal film 18 at a specific incidence angle equal to or larger than the critical angle by the excitation light irradiation unit 31, and an evanescent wave Ew extends over the metal film 18, and the surface plasmon is excited on a surface of the metal film 18 by the evanescent wave Ew. The surface plasmon generates an electric field distribution on the surface of the metal film 18, and an electric field enhancement region is formed. Then, the fluorescence label F bound to the first antibody B1 immobilized on the metal film 18 generates the enhanced fluorescence Lf by being excited by the evanescent wave Ew. The fluorescence detection unit 32 receives the enhanced fluorescence Lf and outputs the fluorescence detection signal corresponding to the amount of the received fluorescence Lf.

Here, the specific incidence angle θ at which the surface plasmon resonance occurs and the enhanced fluorescence Lf is maximized is referred to as a resonance angle. The resonance angle changes depending on a type of the specimen solution SL in contact with the surface of the metal film 18. Therefore, the incidence angle θ of the excitation light Le is adjusted by the incidence angle adjustment mechanism 33.

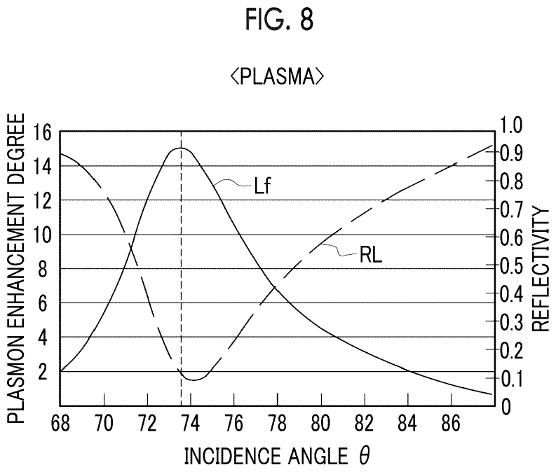

FIG. 8 shows a relationship between the incidence angle θ and each of a plasmon enhancement degree of the fluorescence Lf and a reflectivity of the reflected light RL of the excitation light Le, in a case where blood plasma is used as the specimen. The profile of FIG. 8 is an example in a case where a wavelength of the excitation light Le is 658 nm, a thickness of the metal film 18 is 36 nm, a material of the metal film 18 is gold, and a material of the prism 11A is polymethyl methacrylate (PMMA). Here, the plasmon enhancement degree is an indicator indicating how many times the amount of the enhanced fluorescence Lf is with respect to the reference value, which is the amount of the fluorescence Lf in a case where the enhancement is not performed. Since the plasmon enhancement degree is in a proportional relationship with the amount of the fluorescence Lf detected by the fluorescence detection unit 32, in FIG. 8, even in a case where the vertical axis is the amount of the fluorescence Lf, the relationship between the amount of the fluorescence Lf and the incidence angle θ has the same profile.

In FIG. 8, the incidence angle θ at which the plasmon enhancement degree of the fluorescence Lf shows a peak value and is maximized is specified as the resonance angle. In the example shown in FIG. 8, the resonance angle is 73.6 degrees. Since the excitation light Le consumes energy for the plasmon enhancement, the reflected light RL of the excitation light Le is greatly attenuated near the resonance angle, and the reflectivity shows a minimum value, opposite to the plasmon enhancement degree of the fluorescence Lf. By the incidence angle adjustment, the resonance angle at which the plasmon enhancement degree of the fluorescence Lf shows the maximum value as shown in FIG. 8 is specified.

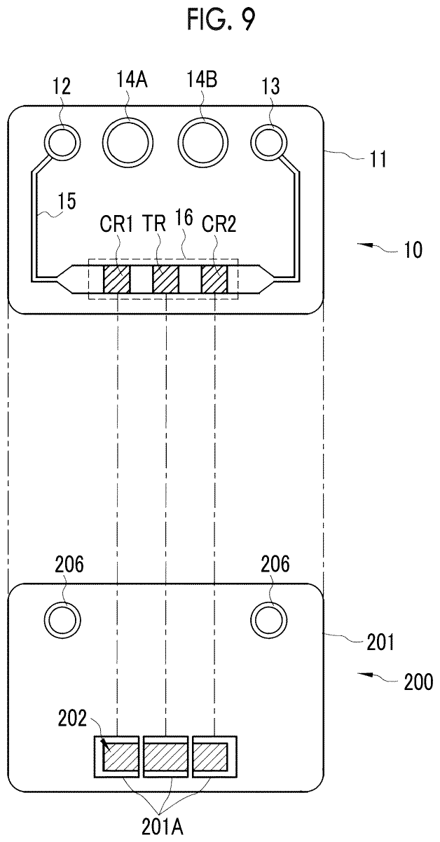

As shown in FIG. 9, the measurement device 100 comprises a check chip 200 used exclusively for checking, which is for performing a check of the measurement unit 30. As the check of the measurement unit 30, for example, an optical check of the measurement unit 30 is performed. That is, the check is whether the fluorescence detection unit 32 can output an appropriate fluorescence detection signal corresponding to the received light amount of the fluorescence Lf or whether the emission amount of the excitation light Le emitted by the excitation light irradiation unit 31 is within an appropriate range set in advance. The abnormality or the failure of the measurement unit 30 is determined based on such a check result. In addition, the emission amount of the excitation light irradiation unit 31 may be reduced due to the deterioration of the measurement unit 30 over time. In this case, the calibration may be performed, such as determining whether the emission amount of the excitation light Le emitted by the measurement unit 30 is within the appropriate range based on the check result, and adjusting the emission amount. The check chip 200 is also called a check cartridge or the like.

The check chip 200 has an outer shape and a size that are substantially the same as those of the analysis chip 10, and is attachable to and detachable from the mounting part 101 in the same manner as the analysis chip 10. The check chip 200 is used in a case where the abnormality or the failure of the measurement unit 30 is suspected or at a timing of the periodic maintenance of the measurement unit 30. In a case of checking the measurement unit 30, the check chip 200 is mounted to the mounting part 101.

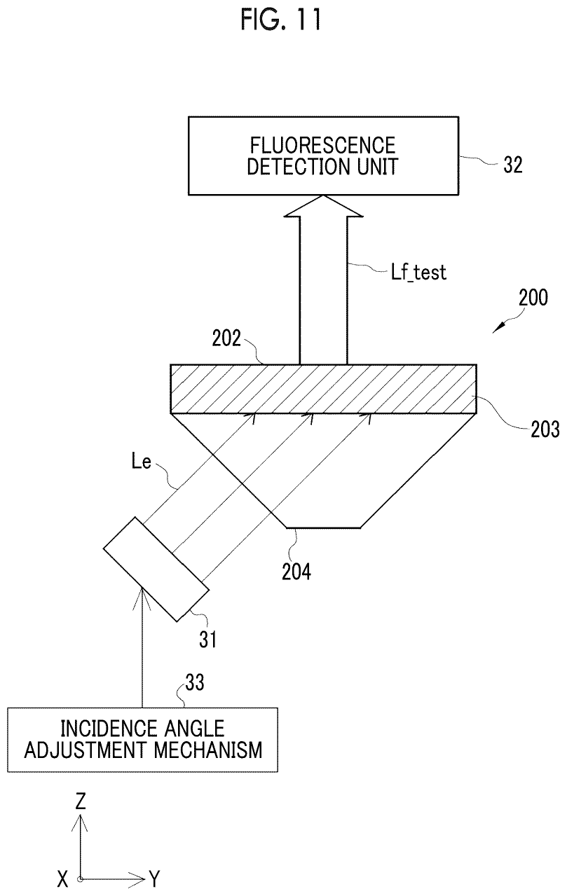

The check chip 200 has a check region 202 for performing the optical check in a body 201. The check region 202 is a region that emits a test fluorescence Lf_test (see FIG. 11) having substantially the same wavelength as the fluorescence Lf by the excitation light Le emitted by the excitation light irradiation unit 31. The check region 202 is a region corresponding to the reaction region 16 of the analysis chip 10, and the outer shape and the size thereof are substantially the same as those of the reaction region 16. In addition, the position of the check region 202 in the body 201 of the check chip 200 is the same as the position of the reaction region 16 in the body 11 of the analysis chip 10. Therefore, the position of the check region 202 in a case where the check chip 200 is mounted to the mounting part 101 is the same as the position of the reaction region 16 in a case where the analysis chip 10 is mounted to the mounting part 101.

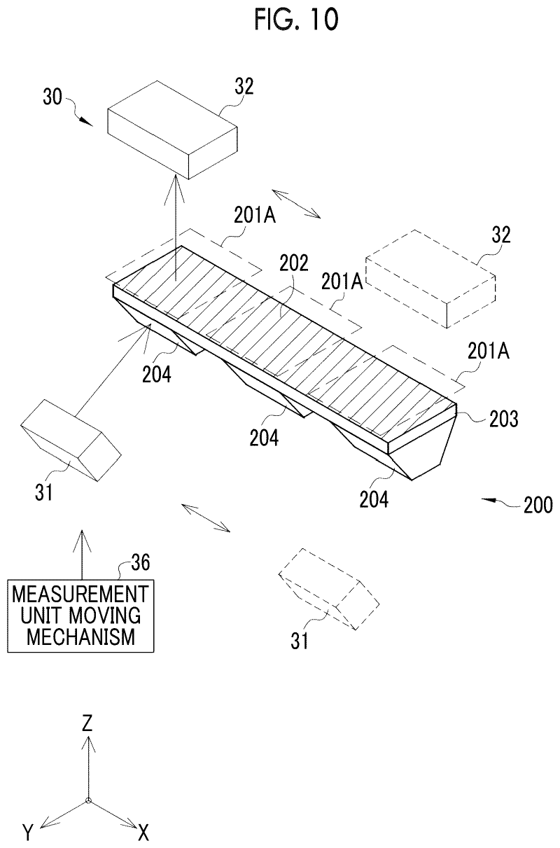

As a result, as shown in FIGS. 10 and 11, a relative positional relationship between the measurement unit 30 and the check region 202 in a case where the mounting part 101 is at the measurement position is the same as the relative positional relationship between the measurement unit 30 and the reaction region 16 shown in FIGS. 6 and 7.

The check region 202 has a thin strip shape as in the reaction region 16. The check region 202 is divided into three in the longitudinal direction by three apertures 201A (see FIG. 9) provided in the body 201. In the check region 202, the regions divided by the three apertures 201A correspond to the first control region CR1, the test region TR, and the second control region CR2.

As shown in FIG. 10, the check region 202 is formed of, for example, a transparent plate 203 made of a resin or glass containing a fluorescent substance. In the transparent plate 203, in a case where a surface facing the fluorescence detection unit 32 is defined as a front surface, a prism 204 is provided on a back surface opposite to the front surface, the prism 204 being the same as the prism 11A of the analysis chip 10.

As shown in FIG. 11, the excitation light Le from the excitation light irradiation unit 31 is transmitted through the prism 204 and is incident on the transparent plate 203 constituting the check region 202. The incident excitation light Le excites the fluorescent substance in the check region 202, and the fluorescent substance emits the test fluorescence Lf_test. The test fluorescence Lf_test is incident on the fluorescence detection unit 32, and the fluorescence detection unit 32 outputs a fluorescence detection signal corresponding to the received light amount of the test fluorescence Lf_test. Since the check region 202 is formed of the transparent plate 203, as in the measurement shown in FIG. 7, the excitation light Le can be emitted from the back surface of the transparent plate 203, and the test fluorescence Lf_test can be emitted toward the fluorescence detection unit 32 disposed on the front surface side of the transparent plate 203.

Each of the apertures 201A restricts the emission amount of the test fluorescence Lf_test such that the received light amount of the test fluorescence Lf_test received by the fluorescence detection unit 32 is substantially the same in a case where the excitation light irradiation unit 31 emits the same excitation light Le at each position of the measurement unit 30 in the X direction (see FIG. 10).

It should be noted that, in the present example, the prism 204 is provided in the check chip 200 as in the analysis chip 10, but the prism 204 may not be provided as long as the check region 202 is irradiated with the excitation light Le and the test fluorescence Lf_test is emitted.

In each position of the measurement unit 30 in the X direction (see FIG. 10), the received light amount of the test fluorescence Lf_test with respect to the emission amount of the excitation light Le is determined by a specification of the check region 202 (a type and a content of the fluorescent substance, and the like). The correspondence relationship between the emission amount and the received light amount is stored in the memory 40B of the control unit 40 or the like in advance.

In a case of checking the measurement unit 30, the measurement device 100 irradiates the check region 202 with the excitation light Le having the emission amount set in advance, and collates the received light amount of the test fluorescence Lf_test received by the fluorescence detection unit 32 in this case with the correspondence relationship stored in the memory 40B. The measurement device 100 determines the abnormality or the failure of the measurement unit 30 as described above based on the collation result, and outputs the check result including the determination result. In addition, the measurement device 100 outputs the received light amount as the check result in accordance with the fluorescence detection signal of the fluorescence detection unit 32. Based on such a check result, the user can determine whether or not the emission amount of the excitation light Le is within the appropriate range, and can perform the optical calibration such as the adjustment of the emission amount of the excitation light Le.

In addition, as shown in FIG. 9, the check chip 200 is provided with an insertion port 206 into which the nozzle tip NC is inserted to check the operation of the specimen processing unit 20, in addition to the optical check region 202. The insertion port 206 is provided in the body 201 at a position corresponding to the inlet port 12 and the outlet port 13 of the analysis chip 10. The measurement device 100 performs the operation check of the pump 22 and the like of the specimen processing unit 20 by causing the specimen processing unit 20 to perform the discharge and the suction of the test liquid using the insertion port 206.

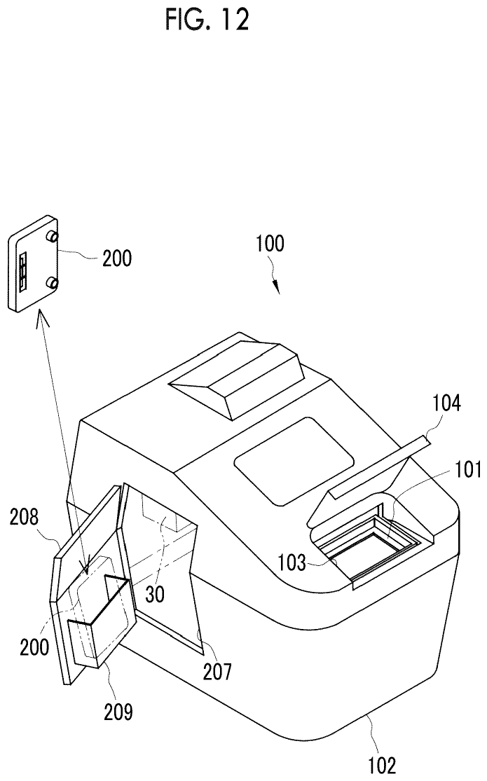

As shown in FIG. 12, a maintenance opening 207 is formed in a side surface of the housing 102 of the measurement device 100. The maintenance opening 207 is an opening for performing maintenance such as cleaning the measurement unit 30 or the nozzle 24. A maintenance door 208 is provided as an opening and closing mechanism configured to open and close the maintenance opening 207. In a case of performing the maintenance, the maintenance door 208 is opened.

An outer surface of the maintenance door 208 constitutes a part of the side surface of the housing 102. A storage part 209 that stores the check chip 200 is provided on an inner surface of the maintenance door 208 facing the inside of the housing 102. The storage part 209 functions as a storage location for storing the check chip 200 while the check chip 200 is not being used. The storage part 209 has, for example, a box shape in which an upper portion is open. Of course, a lid may be provided at the upper opening.

The storage part 209 is provided at a location different from the mounting part 101, and is an example of a “storage part” according to the present disclosed technology. In addition, the inner side of the maintenance door 208 is inside the housing 102 at a position where the check chip 200 stored in the storage part 209 is extractable in a case where the maintenance door 208, which is the opening and closing mechanism, is opened. This position is an example of an “extractable position” according to the present disclosed technology.

As shown in FIG. 13, the maintenance opening 207 is an opening for performing the maintenance of the measurement unit 30. Therefore, the distance between the maintenance opening 207 and the measurement unit 30 is a distance at which the state of the measurement unit 30 can be visually confirmed from the maintenance opening 207 or a distance at which a hand inserted from the maintenance opening 207 can reach the measurement unit 30. In the present example, at least a part of the maintenance opening 207 is disposed at a position overlapping the measurement unit 30 in the depth direction from the front to the rear of the housing 102. In the present example, since the storage part 209 is provided on the inner surface of the maintenance door 208 that opens and closes the maintenance opening 207, in a state where the maintenance door 208 is closed, the storage part 209 is positioned on a side of the measurement unit 30 in the width direction orthogonal to the depth direction of the housing 102. Therefore, the environmental temperatures of the storage part 209 and the measurement unit 30 in the housing 102 are substantially the same.

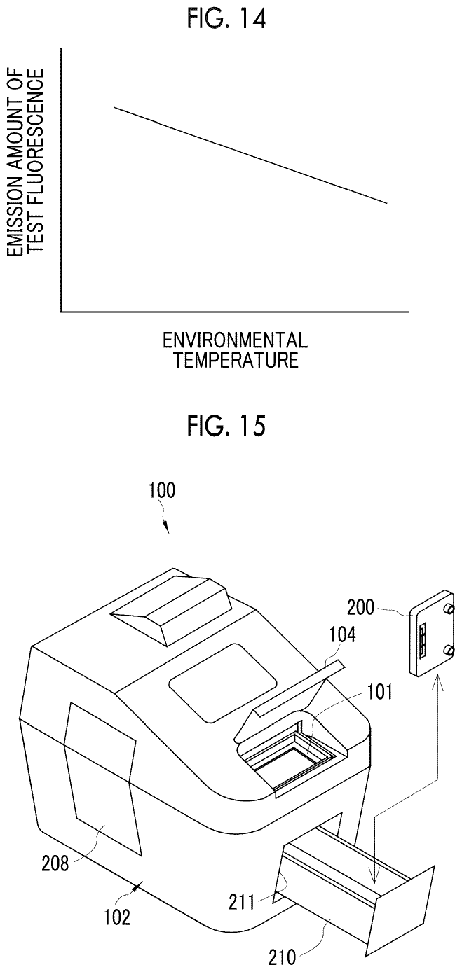

As shown in FIG. 14, the fluorescent substance used in the check region 202 of the check chip 200 has a temperature dependence in the emission amount, and has a characteristic that the emission amount is reduced as the temperature is increased. The emission amount of the test fluorescence Lf_test of the check region 202 is reference information in a case of performing the optical check of the measurement unit 30. Therefore, in a case where the emission amount of the test fluorescence Lf_test changes depending on the temperature state of the storage environment of the check chip 200, there is a concern that the reliability of the check result of the measurement unit 30 cannot be ensured.

In the present example, the storage part 209 is provided inside the housing 102 of the measurement device 100. Therefore, the temperature change in the environment in which the check chip 200 is stored when not in use is smaller than that in a case where the check chip 200 is provided outside the housing 102. Therefore, the emission amount of the test fluorescence Lf_test of the check region 202 is stabilized, and the reliability of the check of the measurement unit 30 is improved.

In addition, the check chip 200 is mounted to the mounting part 101 and is used at the measurement position where the measurement unit 30 is provided in a case of the check. In order to ensure the stability of the emission amount of the test fluorescence Lf_test in a case of the check, it is preferable that the change in the environmental temperature of the storage environment and the use environment is small. In the measurement device 100, the change in the environmental temperature between the storage part 209 in which the check chip 200 is stored when not in use and the measurement position at which the check chip 200 is disposed when in use is small. As described above, since the check chip 200 is stored at substantially the same temperature as the use environment even while not in use, the emission amount of the test fluorescence Lf_test at the time of the check is stabilized. As a result, the reliability of the check of the measurement unit 30 is improved.

It is preferable that the storage part 209 is provided inside the housing 102 at a location where a temperature difference from the environment in which the measurement unit 30 is disposed is within 10° C. It is more preferable that the temperature difference is within 5° C. In the present example, the temperature of the environment in which the storage part 209 is provided and the temperature of the environment in which the measurement unit 30 is disposed are substantially the same, and the requirement that the temperature difference is within 5° C. is satisfied.

The action of the above-described configuration will be described. In the measurement device 100, the check chip 200 is stored in the storage part 209 provided on the inner surface of the maintenance door 208 while not being used for the check of the measurement unit 30. In a case where the abnormality or the failure of the measurement device 100 is suspected or in a case of the periodic maintenance, the check of the measurement unit 30 using the check chip 200 is performed.

The user checks the abnormality of the outer shape or the like of the measurement unit 30 by, for example, opening the maintenance door 208 and looking into the housing 102 from the maintenance opening 207, and performs the check using the check chip 200. Since the check chip 200 is stored in the storage part 209 provided on the inner surface of the maintenance door 208, there is less concern about the loss or the like, and the user can easily find the check chip 200.

The user mounts the check chip 200 on the mounting part 101 at the mounting position and instructs the measurement device 100 to perform the checking process. As shown in FIGS. 2 and 13, the measurement device 100 moves the mounting part 101 from the mounting position to the measurement position. Then, as shown in FIGS. 10 and 11, the measurement device 100 irradiates the check region 202 of the check chip 200 with the excitation light Le from the excitation light irradiation unit 31. In a case where the excitation light Le is emitted to the check region 202, the fluorescent substance of the check region 202 is excited, and the test fluorescence Lf_test is emitted. The fluorescence detection unit 32 receives the test fluorescence Lf_test and outputs a detection signal corresponding to the received light amount.

The control unit 40 outputs the check result to the display part 52 or the like based on the detection signal. In a case where the received light amount is within the appropriate range in advance, the control unit 40 outputs the check result indicating that there is no abnormality or failure in the measurement unit 30 in the checking process using the check chip 200. In a case where the received light amount is not within the appropriate range, the control unit 40 outputs the check result indicating that there is a possibility of the abnormality or the failure. In a case where such a check result is output, the decrease in the output of the excitation light irradiation unit 31 or the failure of the fluorescence detection unit 32 is suspected. In this case, the user adjusts the output of the excitation light irradiation unit 31 or adjusts the gain of the detection signal of the fluorescence detection unit 32, if possible, to calibrate the measurement unit 30. In a case where the failure or the abnormality is not resolved by the calibration, the user requests repair such as the replacement of the measurement unit 30. Of course, the check may be performed by a worker who performs the maintenance of the measurement device 100 instead of the user.

As described above, the measurement device 100 according to the embodiment of the present disclosed technology comprises the check chip 200 for checking the measurement unit 30 and that is attachably and detachably mounted to the mounting part 101, and the storage part 209 that stores the check chip 200 and is provided at a location different from the mounting part 101. Therefore, there is less concern that the check chip 200 will be lost even in a case where the check chip 200 for checking the measurement unit 30 is used.

In addition, the check chip 200 has the check region 202 for performing an optical check of the measurement unit 30, and a position of the check region 202 in a case where the check chip 200 is mounted to the mounting part 101 is the same as a position of the reaction region 16 in a case where the analysis chip 10, which is an example of the measurement chip, is mounted to the mounting part 101. Therefore, the measurement unit 30 can perform the check at the same position as the measurement without moving to a position different from the measurement.

As in the calibration region (corresponding to the check region 202) described in JP2014-071056A, in a case where the position of the calibration region is different from the position of the reaction region, the movement range of the measurement unit 30 is different between the measurement and the check, and there is a concern that the moving mechanism of the measurement unit 30 is complicated. On the other hand, in the measurement device 100 according the embodiment of the present disclosure, the relative positional relationship between the check region 202 and the measurement unit 30 during the check is the same as the relative positional relationship between the reaction region 16 and the measurement unit 30 during the measurement, so that there is less concern that the moving mechanism of the measurement unit 30 is complicated.

The check chip 200 has the check region 202 that emits the test fluorescence Lf_test as the fluorescence by the irradiation with the excitation light Le. Therefore, it is possible to check both the excitation light irradiation unit 31 and the fluorescence detection unit 32. For example, in a case where the check region is checked by using the reflection mirror and the excitation light detector, only the output of the excitation light irradiation unit 31 can be checked. The check region 202 can suppress the complication of the device configuration for the check as compared with such a configuration.

In addition, in the measurement device 100, the housing 102 that accommodates the measurement unit 30 and the mounting part 101 is provided with the maintenance door 208 (an example of an opening and closing mechanism) configured to open and close the maintenance opening 207 (an example of an opening) formed in the housing 102, and the storage part 209 is provided inside the housing 102 at a position where the check chip 200 stored in the storage part 209 is extractable in a case where the maintenance door 208 is opened. In a case where the storage part 209 is provided inside the housing 102, there is less concern about the loss of the check chip 200 as compared with a case where the storage part 209 is provided outside the housing 102.

It should be noted that, in the present example, the storage part 209 is provided inside the housing 102, but the storage part 209 may be provided on, for example, an outer surface of the housing 102. Of course, in a case where the check chip 200 having a low usage frequency is provided outside the housing 102, the usability in a case of normal use may be poor, so that it is preferable that the storage part 209 is provided inside the housing 102 as in the above example.

In addition, since the storage part 209 is at a position where the check chip 200 is extractable in a case where the opening and closing mechanism such as the maintenance door 208 is opened, the check chip 200 stored inside the housing 102 is easily extracted, and the usability is good.

In addition, the opening that is opened and closed by the opening and closing mechanism (for example, the maintenance door 208) and from which the check chip 200 is extractable is the maintenance opening 207 provided for maintenance. Since the maintenance opening 207 is opened and closed during the maintenance, which is a timing at which the check chip 200 is used, the check chip 200 is easily found.

The maintenance opening 207 is a maintenance opening for the measurement unit 30. The check chip 200 is used for the check of the measurement unit 30. Therefore, the usability is improved as compared with a case where the opening from which the check chip 200 is extractable is the maintenance opening other than the measurement unit 30.

The opening and closing mechanism is the maintenance door 208 that opens and closes the maintenance opening 207, and the storage part 209 is provided on the inner side of the maintenance door 208. Therefore, as described above, the check chip 200 is easily found during the maintenance.

In addition, as shown in FIG. 13, the environments in which the storage part 209 and the measurement unit 30 are disposed are substantially the same in the measurement device 100. Therefore, the temperature differences are also substantially the same. Such a position of the storage part 209 is an example of a location at which the temperature difference from the environment in which the measurement unit 30 is disposed is within 10° C., and is also an example of a location at which the temperature difference is within 5° C.

Even in a case where the emission amount of the test fluorescence Lf_test of the check chip 200 has the temperature dependence as shown in FIG. 14, in a case where the temperature difference is within 10° C., the change in the emission amount between the storage and the use of the check chip 200 can be suppressed within a practical range. As a result, the reliability of the check result can be ensured. It is more preferable that the temperature difference is within 5° C. In the present example, since such a temperature condition is satisfied, the reliability of the check result can be ensured. It should be noted that the position of the storage part 209 is not limited to the present example, but it is preferable that a location where the temperature difference is minimized is selected.

In addition, the measurement device 100 measures the reaction by using the surface plasmon resonance. In the cases shown in FIGS. 7 and 8, in a case of using the surface plasmon resonance, it is necessary to specify the resonance angle at which the fluorescence Lf is enhanced based on the detection signal of the fluorescence Lf, so that the calibration of the measurement unit 30 is very important. Therefore, the present disclosed technology related to the check chip 200 for performing a check of the measurement unit 30 is particularly effective.

In the above-described embodiment, the maintenance door 208 is exemplified as the opening and closing mechanism of the opening from which the check chip 200 is extractable, but the opening and closing mechanism may be other than the maintenance door 208. For example, a discard box 210 as shown in FIG. 15 may be used. The discard box 210 is, for example, a box that accommodates the single-use nozzle tip NC. The discard box 210 is removably attached to a box attachment port 211 that is an example of the opening used in the housing 102. The storage part of the check chip 200 may be provided in the discard box 210, or the discard box 210 itself may be used as the storage part. That is, the box attachment port 211 is an example of the opening from which the check chip 200 is extractable, and the discard box 210 is an example of the opening and closing mechanism of the box attachment port 211.

In addition, the storage part may be provided in addition to these, for example, a dedicated check chip 200 extraction port may be provided in the housing 102, and the storage part may be provided near the extraction port. In addition, the opening and closing mechanism may have any form as long as the opening and closing mechanism has a form of blocking the opening. The opening and closing mechanism may be a door type that is rotationally moved by a hinge as in the maintenance door 208 shown in the example, or a door type that is opened and closed by sliding. In addition, the opening and closing mechanism may be a removable lid type or a drawer type such as the discard box 210.

In addition, in the above-described embodiment, the case where the test substance A is an antigen is described as an example, but the test substance A may be an antibody.

In addition, in the above-described embodiment, the measurement device using the surface plasmon resonance is described as an example, but the present disclosure can also be applied to a measurement device that does not use the surface plasmon resonance as long as the measurement device uses the fluorescence excited by the irradiation with the excitation light.

In addition, the technology described in the following supplementary notes can be understood from the above description.

### [Supplementary Note 1]

A measurement device that uses a measurement chip having a reaction region for detecting a test substance and measures a reaction of the test substance in the reaction region by using fluorescence, the measurement device comprising:
a measurement unit that irradiates the reaction region with excitation light and detects the fluorescence emitted from the reaction region;
a mounting part to which the measurement chip is attachably and detachably mounted;
a check chip for performing a check of the measurement unit, the check chip being attachably and detachably mounted to the mounting part; and
a storage part that stores the check chip and is provided at a location different from the mounting part.

### [Supplementary Note 2]

The measurement device according to Supplementary note 1,
in which the check chip has a check region for performing an optical check of the measurement unit, and
a position of the check region in a case where the check chip is mounted to the mounting part is the same as a position of the reaction region in a case where the measurement chip is mounted to the mounting part.

### [Supplementary Note 3]

The measurement device according to Supplementary note 1 or 2, in which the check chip has a check region that emits fluorescence by being irradiated with the excitation light.

### [Supplementary Note 4]

The measurement device according to any one of Supplementary notes 1 to 3,
in which a housing that accommodates the measurement unit and the mounting part is provided with an opening and closing mechanism configured to open and close an opening formed in the housing, and
the storage part is provided inside the housing at a position where the check chip stored in the storage part is extractable in a case where the opening and closing mechanism is opened.

### [Supplementary Note 5]

The measurement device according to Supplementary note 4,
in which the opening is a maintenance opening provided for maintenance.

### [Supplementary Note 6]

The measurement device according to Supplementary note 5,
in which the maintenance opening is a maintenance opening for the measurement unit.

### [Supplementary Note 7]

The measurement device according to Supplementary note 6,
in which a maintenance door that opens and closes the maintenance opening is provided as the opening and closing mechanism, and
the storage part is provided on an inner side of the maintenance door.

### [Supplementary Note 8]

The measurement device according to Supplementary note 4,
in which the storage part is provided inside the housing at a location where a temperature difference from an environment in which the measurement unit is disposed is within 10° C.

### [Supplementary Note 9]

The measurement device according to Supplementary note 8,
in which the temperature difference is within 5° C.

### [Supplementary Note 10]

The measurement device according to any one of Supplementary notes 1 to 9,
in which the reaction is measured by using surface plasmon resonance.

Although the preferred embodiments of the present disclosure have been described above, the present disclosure is not limited to the above-described embodiments, and various configurations can be adopted as long as the spirit of the present disclosure is not departed from, such as a combination of each embodiment and each modification example.

In addition, in the above-described embodiment, for example, as a hardware structure of a processor that executes various types of processing, such as the control unit 40, various processors shown below can be used. Various processors include a programmable logic device (PLD) that is capable of changing a circuit configuration after manufacturing, such as a field-programmable gate array (FPGA), and a dedicated electric circuit that is a processor having a circuit configuration dedicatedly designed for executing specific processing, such as an application specific integrated circuit (ASIC), in addition to a CPU that is a general-purpose processor configured to execute software (program) to function as various processing units.

Various types of processing described above may be executed by one of the various processors or may be executed by a combination of two or more processors (for example, a combination of a plurality of FPGAs or a CPU and an FPGA) of the same type or different types. A plurality of processing units may be configured by one processor. As an example in which the plurality of processing units are configured with one processor, there is a form in which a processor that realizes all functions of a system including the plurality of processing units by using one integrated circuit (IC) chip is used, such as a system on chip (SOC).

In this manner, the various processing units are configured, as hardware structures, using one or more of the various types of processors described above.

Furthermore, the hardware structure of these various processors is, more specifically, an electric circuit (circuitry) in which circuit elements such as semiconductor elements are combined.

In addition to the operation program of the measurement device 100, the technology of the present disclosure extends to a computer readable storage medium (USB memory or digital versatile disc (DVD)-read only memory (ROM), or the like) that stores the operation program of the measurement device 100 in a non-transitory manner.

The described contents and the illustrated contents are detailed explanations of a part according to the technique of the present disclosure, and are merely examples of the technique of the present disclosure. For example, description related to the above configurations, functions, actions, and effects is description related to examples of configurations, functions, actions, and effects of the parts according to the present disclosed technology. Thus, unnecessary parts may be removed, new elements may be added, or the parts may be replaced with each other in the content of description and the content of illustration shown above without departing from the gist of the present disclosed technology. In addition, in order to avoid complication and facilitate the understanding of a portion according to the present disclosed technology, regarding the contents described and illustrated above, description related to common technical knowledge or the like which does not need to be described to enable implementation of the present disclosed technology has been omitted.

In the present specification, “A and/or B” is synonymous with “at least one of A or B”. That is, “A and/or B” may be only A, only B, or a combination of A and B. In the present specification, the same approach as “A and/or B” also applies to an expression of three or more matters connected with “and/or”.

The disclosure of JP2023-140446 filed on Aug. 30, 2023 is incorporated herein by reference in its entirety. In addition, all documents, patent applications, and technical standards described in the present specification are incorporated in the present specification by reference to the same extent as in a case where each document, patent application, and technical standard are specifically and individually noted to be incorporated by reference.

What is claimed is:

1. A measurement device that uses a measurement chip having a reaction region for detecting a test substance and measures a reaction of the test substance in the reaction region by using fluorescence, the measurement device comprising:
a measurement unit that irradiates the reaction region with excitation light and detects the fluorescence emitted from the reaction region;
a mounting part to which the measurement chip is attachably and detachably mounted;
a check chip for performing a check of the measurement unit, the check chip being attachably and detachably mounted to the mounting part; and
a storage part that stores the check chip and is provided at a location different from the mounting part.

2. The measurement device according to claim 1,
wherein the check chip has a check region for performing an optical check of the measurement unit, and
a position of the check region in a case where the check chip is mounted to the mounting part is the same as a position of the reaction region in a case where the measurement chip is mounted to the mounting part.

3. The measurement device according to claim 1,
wherein the check chip has a check region that emits fluorescence by being irradiated with the excitation light.

4. The measurement device according to claim 1,
wherein a housing that accommodates the measurement unit and the mounting part is provided with an opening and closing mechanism configured to open and close an opening formed in the housing, and
the storage part is provided inside the housing at a position where the check chip stored in the storage part is extractable in a case where the opening and closing mechanism is opened.

5. The measurement device according to claim 4, wherein the opening is a maintenance opening provided for maintenance.

6. The measurement device according to claim 5, wherein the maintenance opening is a maintenance opening for the measurement unit.

7. The measurement device according to claim 6,
wherein a maintenance door that opens and closes the maintenance opening is provided as the opening and closing mechanism, and
the storage part is provided on an inner side of the maintenance door.

8. The measurement device according to claim 4,
wherein the storage part is provided inside the housing at a location where a temperature difference from an environment in which the measurement unit is disposed is within 10° C.

9. The measurement device according to claim 8,
wherein the temperature difference is within 5° C.

10. The measurement device according to claim 1,
wherein the reaction is measured by using surface plasmon resonance.
